(19) United States
(12) Patent Application Publication
(10) Pub. No.: US 2010/0237611 A1
(43) Pub. Date: Sep. 23, 2010

(54) Hose and Connector Assembly Having Greater Strength

(76) Inventor: Ya-Ling Hung, Lugang Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/405,463

(22) Filed: Mar. 17, 2009

(51) Int. Cl. F16L 35/00

(52) U.S. Cl. 285/331

(57) ABSTRACT

A hose and connector assembly includes a connector, a hose having an end portion inserted into the connector and a fastening member mounted in the end portion of the hose and abutting the connector. The connector has a first mounting hole, a mounting hole and a stepped portion located between the first mounting hole and the second mounting hole. The end portion of the hose has a periphery provided with a stop flange abutting the stepped portion of the connector. The fastening member has a periphery provided with a limit flange abutting the stop flange of the hose. Thus, the end portion of the hose is sandwiched between the connector and the fastening member to enhance the combination strength of the hose and the connector.

### BACKGROUND OF THE INVENTION

1. Field of the Invention

The present invention relates to a hose and connector assembly and, more particularly, to a hose and connector assembly for a shower head.

2. Description of the Related Art

A conventional hose and connector assembly in accordance with the prior art shown in FIGS. 7 and 8 comprises a connector 70 and a hose 60 having an end portion 62 inserted into and secured in the connector 70. In fabrication, a flexible die is inserted into the connector 70 and the hose 60. Then, an expanding machine is inserted into the flexible die to expand the flexible die radially and outwardly and to press the end portion 62 of the hose 60 toward the connector 70 so that the end portion 62 of the hose 60 presses the inner wall of the connector 70 so as to combine the end portion 62 of the hose 60 and the connector 70 together.

However, the hose 60 is often moved relative to the connector 70 so that the hose 60 is easily detached from the connector 70 during a long-term utilization. In addition, the end portion 62 of the hose 60 is not located in the connector 70 before assembly, thereby causing inconvenience to operation of the expanding machine and the flexible die. Further, after the end portion 62 of the hose 60 is pressed by the expanding machine, the end portion 62 of the hose 60 easily produces burrs which easily tears or scratches a plastic pipe which is inserted into the hose 60. Further, after the end portion 62 of the hose 60 is pressed by the expanding machine to secure the connector 70, an operator needs to cut a residual portion of the hose 60, thereby increasing the cost of fabrication.

### BRIEF SUMMARY OF THE INVENTION

In accordance with the present invention, there is provided a hose and connector assembly, comprising a connector, a hose having an end portion inserted into the connector and a fastening member mounted in the end portion of the hose and abutting the connector so that the end portion of the hose is sandwiched between the connector and the fastening member. The connector has a first end provided with a first mounting hole, a second end provided with a second mounting hole and a mediate portion provided with a stepped portion located between the first mounting hole and the second mounting hole. The end portion of the hose has a periphery provided with an enlarged stop flange abutting the stepped portion of the connector. The fastening member has a periphery provided with an enlarged limit flange abutting the stop flange of the hose.

The primary objective of the present invention is to provide a hose and connector assembly having greater strength.

Another objective of the present invention is to provide a hose and connector assembly, wherein the fastening member is mounted in the end portion of the hose and presses the end portion of the hose toward the connector so that the end portion of the hose is sandwiched between the connector and the fastening member to enhance the combination strength of the hose and the connector.

A further objective of the present invention is to provide a hose and connector assembly, wherein the hose and the connector are combined together solidly and exactly by provision of the fastening member so that the hose and the connector will not detach from each other during a long-term utilization.

A further objective of the present invention is to provide a hose and connector assembly, wherein the fastening member is mounted in the end portion of the hose to locate the position of the hose to facilitate operation of the expanding machine and the flexible die.

A further objective of the present invention is to provide a hose and connector assembly, wherein the fastening member is located between the end portion of the hose and the flexible die to prevent the end portion of the hose from producing burrs during operation of the expanding machine.

A further objective of the present invention is to provide a hose and connector assembly, wherein the stop flange of the hose is sandwiched between the stepped portion of the connector and the limit flange of the fastening member, so that an operator needs not to cut the hose after fabrication, thereby decreasing the cost of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hose and connector assembly in accordance with the preferred embodiment of the present invention.

FIG. 2 is an exploded perspective view of the hose and connector assembly as shown in FIG. 1.

FIG. 3 is a front cross-sectional view of the hose and connector assembly before a working process as shown in FIG. 1.

FIG. 4 is a front cross-sectional view showing the working process of the hose and connector assembly as shown in FIG. 3.

FIG. 5 is a front cross-sectional view of the hose and connector assembly after the working process as shown in FIG. 1.

FIG. 6 is a front cross-sectional view of a hose and connector assembly in accordance with another preferred embodiment of the present invention.

FIG. 7 is an exploded perspective view of a conventional hose and connector assembly in accordance with the prior art.

FIG. 8 is a front cross-sectional assembly view of the conventional hose and connector assembly as shown in FIG. 7.

### DETAILED DESCRIPTION OF THE INVENTION

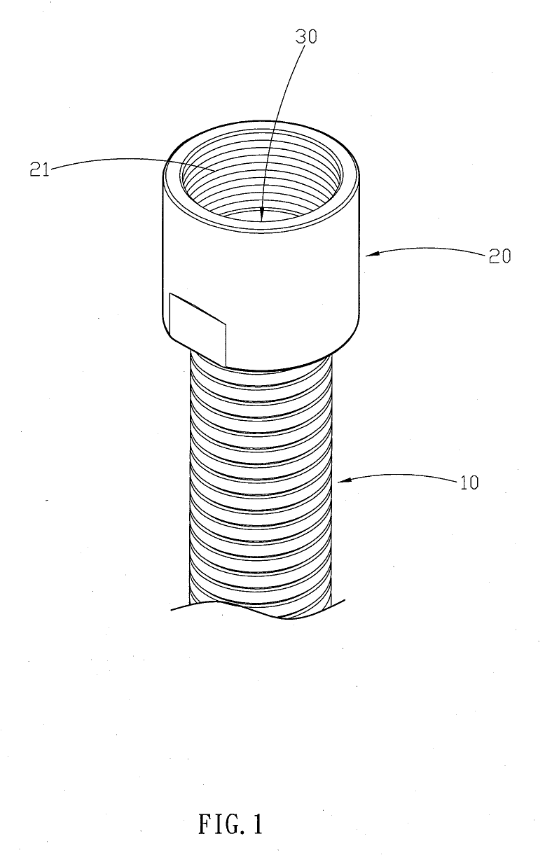

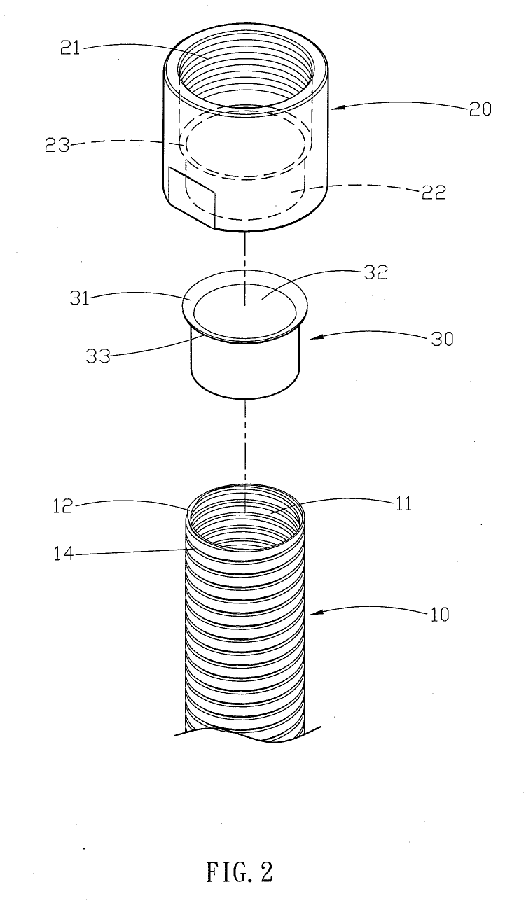

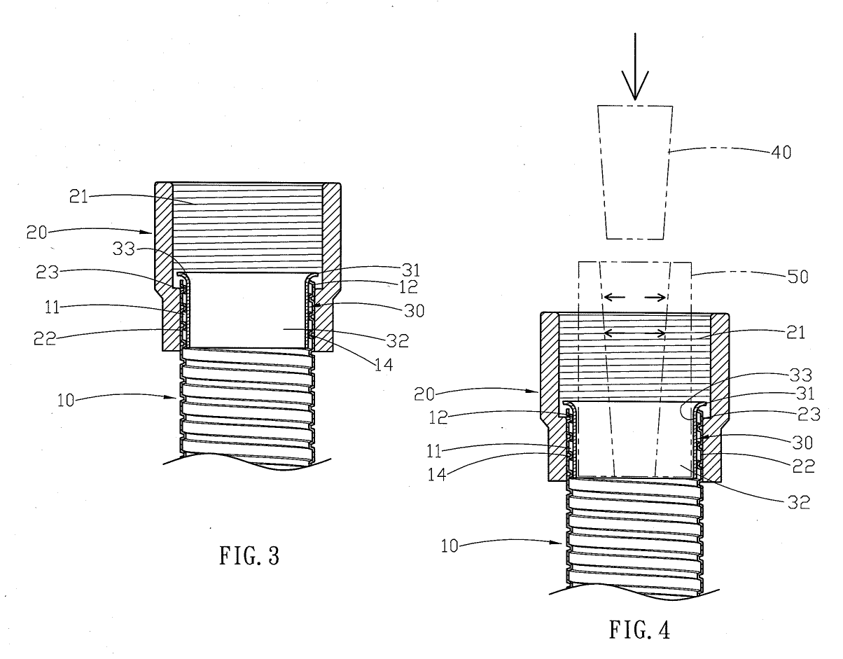

Referring to the drawings and initially to FIGS. 1-5, a hose and connector assembly in accordance with the preferred embodiment of the present invention comprises a connector 20, a hose 10 having an end portion 14 inserted into the connector 20, and a fastening member 30 mounted in the end portion 14 of the hose 10 and abutting the connector 20 so that the end portion 14 of the hose 10 is sandwiched between the connector 20 and the fastening member 30.

The connector 20 has a first end provided with a first mounting hole 22, a second end provided with a second mounting hole 21 and a mediate portion provided with a stepped portion 23 located between the first mounting hole 22 and the second mounting hole 21. The second mounting hole 21 of the connector 20 is a screw bore and has a diameter greater than that of the first mounting hole 22.

The hose 10 has an inner portion provided with a receiving space 11 to receive the fastening member 30. The end portion 14 of the hose 10 is received in the first mounting hole 22 of the connector 20 and has a periphery provided with an enlarged stop flange 12 abutting the stepped portion 23 of the connector 20. The stop flange 12 of the hose 10 extends radially and outwardly from the end portion 14 of the hose 10 and is received in the second mounting hole 21 of the connector 20. The stop flange 12 of the hose 10 abuts a peripheral wall of the second mounting hole 21 of the connector 20. The stop flange 12 of the hose 10 is bent radially and outwardly and has a substantially arcuate cross-sectional profile.

The fastening member 30 is made of copper and has a tubular shape. The fastening member 30 has an inner portion provided with a passage 32 connected to the second mounting hole 21 of the connector 20. The fastening member 30 has a periphery 33 provided with an enlarged limit flange 31 abutting the stop flange 12 of the hose 10 so that the stop flange 12 of the hose 10 is sandwiched between the stepped portion 23 of the connector 20 and the limit flange 31 of the fastening member 30. The limit flange 31 of the fastening member 30 extends radially and outwardly from the periphery 33 of the fastening member 30 and is received in the second mounting hole 21 of the connector 20. The limit flange 31 of the fastening member 30 abuts the peripheral wall of the second mounting hole 21 of the connector 20. The limit flange 31 of the fastening member 30 is bent radially and outwardly and has a substantially arcuate cross-sectional profile.

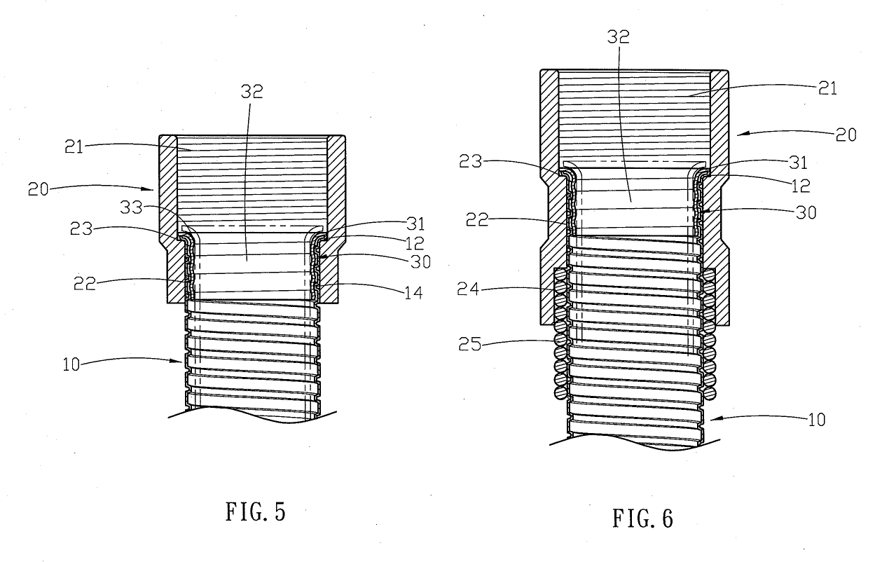

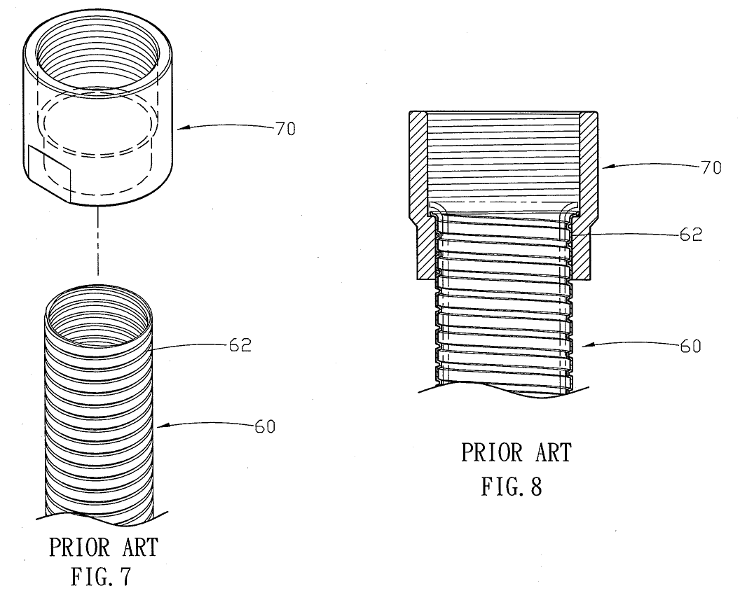

In fabrication, referring to FIGS. 4 and 5 with reference to FIGS. 1-3, a flexible die 50 is inserted into the second mounting hole 21 of the connector 20 and the passage 32 of the fastening member 30 as shown in FIG. 4. Then, an expanding machine 40 is inserted into the flexible die 50 to expand the flexible die 50 radially and outwardly and to press the fastening member 30 and the end portion 14 of the hose 10 toward the connector 20 so that the end portion 14 of the hose 10 is formed with the enlarged stop flange 12 abutting the stepped portion 23 of the connector 20, and the periphery 33 of the fastening member 30 is formed with the enlarged limit flange 31 abutting the stop flange 12 of the hose 10 as shown in FIG. 5.

As shown in FIG. 6, the hose and connector assembly further comprises a protective member 25 mounted between the hose 10 and the connector 20 to protect the hose 10. The first end of the connector 20 is provided with a receiving recess 24 connected to the first mounting hole 22 to receive the protective member 25. The receiving recess 24 of the connector 20 has a diameter greater than that of the first mounting hole 22.

Accordingly, the fastening member 30 is mounted in the end portion 14 of the hose 10 and presses the end portion 14 of the hose 10 toward the connector 20 so that the end portion 14 of the hose 10 is sandwiched between the connector 20 and the fastening member 30 to enhance the combination strength of the hose 10 and the connector 20. In addition, the hose 10 and the connector 20 are combined together solidly and exactly by provision of the fastening member 30 so that the hose 10 and the connector 20 will not detach from each other during a long-term utilization. Further, the fastening member 30 is mounted in the end portion 14 of the hose 10 to locate the position of the hose 10 to facilitate operation of the expanding machine 40 and the flexible die 50. Further, the fastening member 30 is located between the end portion 14 of the hose 10 and the flexible die 50 to prevent the end portion 14 of the hose 10 from producing burrs during operation of the expanding machine 40. Further, the stop flange 12 of the hose 10 is sandwiched between the stepped portion 23 of the connector 20 and the limit flange 31 of the fastening member 30, so that an operator needs not to cut the hose 10 after fabrication, thereby decreasing the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hose and connector assembly, comprising:
a connector;
a hose having an end portion inserted into the connector;
a fastening member mounted in the end portion of the hose and abutting the connector so that the end portion of the hose is sandwiched between the connector and the fastening member.

2. The hose and connector assembly of claim 1, wherein
the connector has a first end provided with a first mounting hole, a second end provided with a second mounting hole and a mediate portion provided with a stepped portion located between the first mounting hole and the second mounting hole;
the end portion of the hose has a periphery provided with an enlarged stop flange abutting the stepped portion of the connector;
the fastening member has a periphery provided with an enlarged limit flange abutting the stop flange of the hose.

3. The hose and connector assembly of claim 1, wherein the stop flange of the hose is sandwiched between the stepped portion of the connector and the limit flange of the fastening member.

4. The hose and connector assembly of claim 2, further comprising:
a protective member mounted between the hose and the connector to protect the hose.

5. The hose and connector assembly of claim 4, wherein the first end of the connector is provided with a receiving recess connected to the first mounting hole to receive the protective member.

6. The hose and connector assembly of claim 5, wherein the receiving recess of the connector has a diameter greater than that of the first mounting hole.

7. The hose and connector assembly of claim 2, wherein the end portion of the hose is received in the first mounting hole of the connector.

8. The hose and connector assembly of claim 2, wherein the stop flange of the hose extends radially and outwardly from the end portion of the hose.

9. The hose and connector assembly of claim 1, wherein the stop flange of the hose is received in the second mounting hole of the connector.

10. The hose and connector assembly of claim 2, wherein the stop flange of the hose abuts a peripheral wall of the second mounting hole of the connector.

11. The hose and connector assembly of claim 10, wherein the limit flange of the fastening member abuts the peripheral wall of the second mounting hole of the connector.

12. The hose and connector assembly of claim 2, wherein the stop flange of the hose is bent radially and outwardly.

13. The hose and connector assembly of claim 2, wherein the stop flange of the hose has a substantially arcuate cross-sectional profile.

14. The hose and connector assembly of claim 2, wherein the fastening member has an inner portion provided with a passage connected to the second mounting hole of the connector.

15. The hose and connector assembly of claim 2, wherein the limit flange of the fastening member extends radially and outwardly from the periphery of the fastening member.

16. The hose and connector assembly of claim 2, wherein the limit flange of the fastening member is received in the second mounting hole of the connector.

17. The hose and connector assembly of claim 2, wherein the limit flange of the fastening member is bent radially and outwardly.

18. The hose and connector assembly of claim 2, wherein the limit flange of the fastening member has a substantially arcuate cross-sectional profile.

19. The hose and connector assembly of claim 1, wherein the hose has an inner portion provided with a receiving space to receive the fastening member.

20. The hose and connector assembly of claim 1, wherein the fastening member is made of copper and has a tubular shape.
